(19) United States
(12) Patent Application Publication
(10) Pub. No.: US 2019/0394084 A1
(43) Pub. Date: Dec. 26, 2019

(54) NETWORK LINK TOPOLOGY ADAPTATION METHOD FOR INTERGRATED ACCESS AND BACKHAUL NODE AND INTERGRATED ACCESS AND BACKHAUL NODE USING THE SAME

(71) Applicant: Industrial Technology Research Institute, Hsinchu (TW)

(72) Inventors: Tzu-Jane Tsai, Hsinchu County (TW); Chun-Yuan Chiu, Pingtung County (TW); Jung-Mao Lin, Hsinchu County (TW)

(73) Assignee: Industrial Technology Research Institute, Hsinchu (TW)

(21) Appl. No.: 16/430,420

(22) Filed: Jun. 3, 2019

Related U.S. Application Data
(60) Provisional application No. 62/687,259, filed on Jun. 20, 2018.

(51) Int. Cl. H04L 12/24; H04W 36/12; H04L 12/807; H04L 12/26; H04W 36/00; H04W 74/08

(52) U.S. Cl. CPC H04L 41/0668; H04W 36/125; H04L 47/27; H04W 74/0833; H04L 41/12; H04W 36/0069; H04L 43/16

(57) ABSTRACT

The disclosure is directed to a network link topology adaptation method for an IAB node and an IAB node using the same method. In an aspect, the disclosure is directed to a network link topology adaptation method used by a transmitting IAB node, and the method would include not limited to: receiving a topology adaptation configuration which comprises a blockage-related parameter from an upstream IAB node; determining whether a blockage condition of a radio link has occurred based on the blockage-related parameter; and transmitting a request to trigger a switch from a first network link topology to a second network link topology.

### CROSS REFERENCE TO RELATED APPLICATION

This application claims the priority benefit of U.S.A. provisional application Ser. No. 62/687,259, filed on Jun. 20, 2018. The entirety of the above-mentioned patent application is hereby incorporated by reference herein and made a part of specification.

### TECHNICAL FIELD

The disclosure is directed to a network link topology adaptation method for an integrated access and backhaul (IAB) node and an IAB node using the same method.

### BACKGROUND

Currently in Fifth Generation (5G) new radio (NR), the millimeter wave (mmWave) spectrum to be used. Because the available bandwidth for the 5G NR communication system is larger than the available bandwidth of the Long-Term Evolution (LTE) communication system coupled with the new deployment of massive multi-input multi-output (MIMO) or multi-beam communication system of the upcoming 5G NR communication system, there will be opportunities to develop and deploy integrated IAB links.

FIG. 1 illustrates an example of a plurality of IAB nodes in a 5G NR communication system. For the communication system of FIG. 1, there could be at least three IAB nodes which provides wireless accesses to multiple user equipment (UEs) and are connected to one another through backhaul links which could be cabled or wireless. For instance, IAB node A may receive information from the core network via a fiber optic transport and deliver such information to IAB nodes B or C through the respective backhaul link as each IAB node may provide accesses for one or more UEs. Such network scheme may allow an easier deployment of a dense network of interconnected cells by building upon many control and data channels or procedures that are integrated for providing accesses to UEs.

However, such deployment scheme of FIG. 1 could be vulnerable to blockages since 5G NR has gravitated toward antennas having directional properties. The blockages could be temporary such as the result of moving objects (e.g. vehicles), less temporarily such as seasonal changes (e.g. foliage), or more permanent in nature such as infrastructure changes (e.g. new buildings). Such vulnerability could be more prominent for IAB-nodes that are physically stationary. Also, traffic variations can create uneven load distributions on wireless backhaul links leading to congestions.

FIG. 2A-2B illustrates how IAB nodes may react to a network blockage. Referring to FIG. 2A, assuming that a first IAB node 201 receives information from an IAB donor and forwards the information to a second IAB node 202, but a blockage has occurred between the first IAB node 201 and the second IAB node 202. Under such scenario, the network would need to react promptly and correctly. For instance, the network may re-route the transmission so that the IAB donor transmit information to a third IAB node 203 through the first IAB node 201 so that the third IAB node 203 may forward the information to the second node 202.

Referring to FIG. 2B, assuming that the first IAB node 201 receives information from an IAB donor and forwards the information to the third IAB node 202, but a blockage has occurred between the first IAB node 201 and the third IAB node 203. Under such scenario, the network would need to locate a suitable second upstream node and at the same time attempt the signaling overhead should be reduced. For instance, the network may re-route the transmission so that the IAB donor transmit information to a fourth IAB node 204 which will forward the information to the third IAB child node 203. Such endeavor is likely more efficient than the fourth IAB node 204 forwarding the information to the third IAB child node 203 through a fifth IAB node 205.

It can be observed that the above described adaptation could be heavily dependent on the network topology, and the network would need to implement a proper topology adaption mechanism in order to resolve the blockages. The topology adaptation would involve procedures that autonomously reconfigure the backhaul network under circumstances such as blockages or congestions without discontinuing services to UEs. Thus, physically fixed relays such as IAB nodes would need to have a mechanism to dynamically adapt so as to mitigate blockages and congestions.

The topology adaptation could affect network performances as different topology may impact a network in different ways. For instance, an IAB-node that has only one upstream node IAB node may have only one upstream IAB node and thus has the simplicity of routing due to having only one path between a source and a destination and the requirement to only maintain one active radio link to perform tasks such as monitoring physical downlink-controlled channel (PDCCH), communicating buffer status report, synchronizing downlink (DL) and uplink (UL), communicating physical head room (PHR), and so forth. However, when a link is bad, a subsequent re-selection and handover procedure may result approximately 350˜15 ms of service interruption.

An IAB-node that has more than one upstream IAB node has a high reliability and a quick path switch since a supporting secondary cell group (SCG) could be switched to being a master cell group (MCG) directly instead of undergoing the add and release procedure in LTE. But because of the requirement of maintaining more than one active radio links, the network could be incurred with an increased complexity of routing due to having multiple paths as well as due to the maintenance of multiple entries of routing tables from a source to a destination, and etc.

Since an IAB node may have to dynamically react to blockages and network congestions, another a robust mechanism for implementing network adaptation by an IAB node could be adopted.

### SUMMARY OF THE DISCLOSURE

Accordingly, the disclosure is directed to a network link topology adaptation method for an IAB node and an IAB node using the same method.

In an aspect, the disclosure is directed to a network link topology adaptation method used by a transmitting IAB node, and the method would include not limited to: receiving a topology adaptation configuration which comprises a blockage-related parameter from an upstream IAB node; determining whether a blockage condition of a radio link has occurred based on the blockage-related parameter; and transmitting a request to trigger a switch from a first network link topology to a second network link topology.

In an aspect, the disclosure is directed to a network link topology adaptation method used by a receiving IAB node, and the method would include not limited to: transmitting a topology adaptation configuration which comprises a blockage-related parameter; receiving a request which indicates to trigger a switch from a first network link topology to a second network link topology; and transmitting a command to trigger a switch from a first network link topology to a second network link topology.

In an aspect, the disclosure is directed to a transmitting IAB node which includes not limited to: a transceiver and a processor coupled to the transceiver. The processor is configured at least to: receive a topology adaptation configuration which comprises a blockage-related parameter from an upstream IAB node; determine whether a blockage condition of a radio link has occurred based on the blockage-related parameter; and transmit a request to trigger a switch from a first network link topology to a second network link topology.

In an aspect, the disclosure is directed to a receiving IAB node which includes not limited to: a transceiver and a processor coupled to the transceiver. The processor is configured at least to: transmit a topology adaptation configuration which comprises a blockage-related parameter; receive a request which indicates to trigger a switch from a first network link topology to a second network link topology; and transmit a command to trigger a switch from a first network link topology to a second network link topology.

In order to make the aforementioned features and advantages of the disclosure comprehensible, exemplary embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the disclosure and is therefore not meant to be limiting or restrictive in any manner. Also, the disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 shows an example of a 5G NR communication network in which a plurality of IAB nodes are deployed to provide accesses to UEs and to provide backhaul links.

FIG. 2A-2B illustrates how IAB nodes may react to a network blockage.

FIG. 3A illustrates a network link topology adaptation method used by a transmitting IAB node or a user equipment according to one of the exemplary embodiments of the disclosure.

FIG. 3B illustrates a network link topology adaptation method used by a receiving IAB node according to one of the exemplary embodiments of the disclosure.

FIG. 4 illustrates a transmitting IAB node or a receiving IAB node according to one of the exemplary embodiments of the disclosure.

FIG. 5 is a signaling diagram which illustrates transmitting a Second Serving IAB Request according to one of the exemplary embodiments of the disclosure.

FIG. 6 illustrates a BFR detection mechanism according to one of the exemplary embodiments of the disclosure.

FIG. 7 illustrates a first exemplary embodiment of the BFR detection mechanism.

FIG. 8 illustrates a second exemplary embodiment of the BFR detection mechanism.

FIG. 9 illustrates a third exemplary embodiment of the BFR detection mechanism.

FIG. 10 illustrates a fourth exemplary embodiment of the BFR detection mechanism.

FIG. 11 illustrates an RLF (Radio Link Failure) detection mechanism according to one of the exemplary embodiments of the disclosure.

FIG. 12 illustrates a first exemplary embodiment of the RLF detection mechanism.

FIG. 13 illustrates a second exemplary embodiment of the RLF detection mechanism.

FIG. 14 illustrates a third exemplary embodiment of the RLF detection mechanism.

FIG. 15 illustrates a fourth exemplary embodiment of the RLF detection mechanism.

FIG. 16 illustrates a first exemplary embodiment of a Reference Signals Received Power (RSRP)/Reference Signal Received Quality (RSRQ) evaluation mechanism.

FIG. 17 illustrates a second exemplary embodiment of a RSRP/RSRQ evaluation mechanism

FIG. 18 is a signaling diagram which illustrates an addition of a second serving IAB node according to one of the exemplary embodiments of the disclosure.

FIG. 19 is a signaling diagram which illustrates releasing a second serving IAB according to one of the exemplary embodiments of the disclosure.

FIG. 20 is a signaling diagram which illustrates handing over to a second serving IAB according to one of the exemplary embodiments of the disclosure.

FIG. 21 is a signaling diagram which illustrates another exemplary embodiment of handing over to a second serving IAB.

FIG. 22 illustrates a signaling diagram which illustrates an exemplary embodiment of handing over to a target IAB according to one of the exemplary embodiments of the disclosure.

FIG. 23 illustrates a signaling diagram which illustrates changing a second serving IAB according to one of the exemplary embodiments of the disclosure.

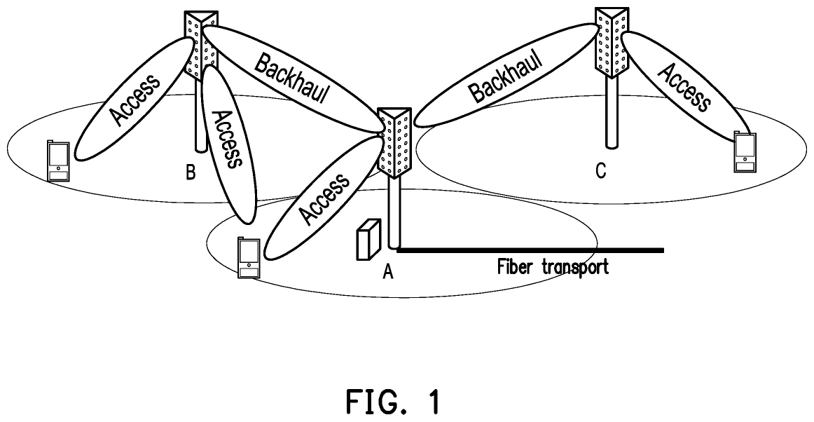

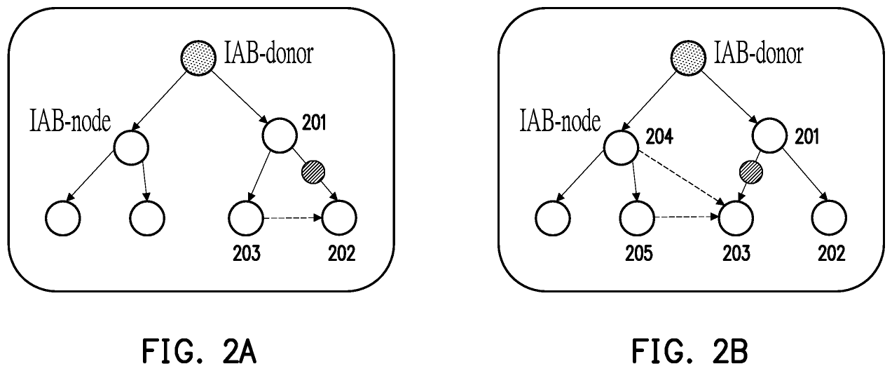

### DETAILED DESCRIPTION OF DISCLOSED EMBODIMENTS

Reference will now be made in detail to the present exemplary embodiments of the disclosure, examples of which are illustrated in the accompanying drawings. Wherever possible, the same reference numbers are used in the drawings and the description to refer to the same or like parts.

For the above described challenges, the disclosure proposes a solution which includes ways to detect blockage conditions by using techniques such as detecting beam failure recovery (BFR), detecting radio link failure (RLF), and measuring signal strength according to its reference signal received power (RSRP) or reference signal received quality (RSRQ). In response to detecting a blockage condition, a network may adapt to the condition by changing its network link topology. For example, an IAB node may transmit a request to trigger a dual connectivity (DC) to add, change, or delete another IAB node of its interaction, or the data traffic could be handed over to another IAB node. The disclosure also provides four IAB-DC procedures which include a procedure to add a second serving IAB node, a procedure to release a second serving IAB node, a procedure to handover a radio link to a second serving or target IAB node, and a procedure to change a second serving IAB node.

It might be worth noting that while an IAB-node can send a request to establish an IAB-DC, beam measurement reports would not be suitable since IAB nodes are likely physically fixed, and the beam measurement reports may require a long period for the report to be finished. However, blockage conditions may also be short term, and thus a blockage condition by occurs without a serving node being aware of the blockage. Also, a child node may not report the blockage condition promptly. Consequently, service interruptions may cause harms to the wireless backhaul.

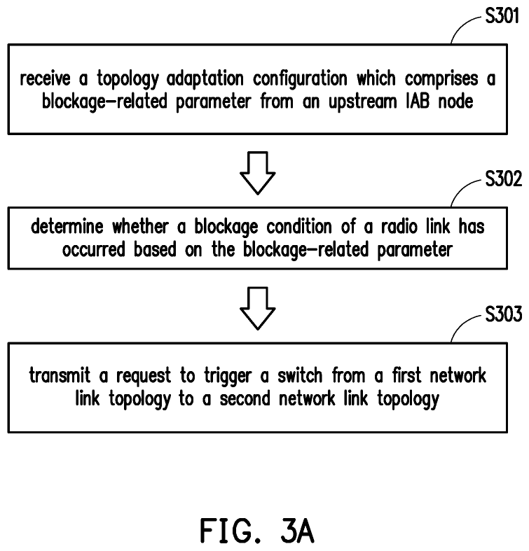

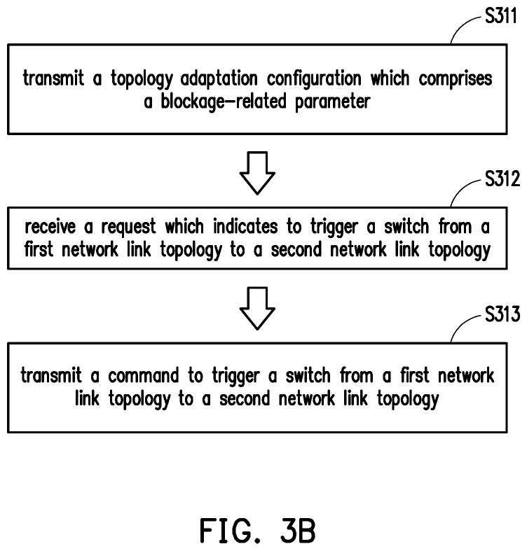

FIG. 3A illustrates a network link topology adaptation method used by a transmitting IAB node or a user equipment according to one of the exemplary embodiments of the disclosure. In step S301, the IAB node would receive a topology adaptation configuration which includes a blockage-related parameter from an upstream IAN node. In step S302, after receiving the topology adaptation configuration, the IAB node would determine whether a blockage condition of a radio link has occurred based on the blockage-related parameter. In step S303, the IAB node would transmit a request to trigger a switch from a first network link topology or a second network link topology.

The blockage condition could be determined in various ways including detecting BFR, detecting RLF, or measuring RSRP or RSRQ. One such embodiment includes determining whether one or more preamble transmission during the Beam Failure Recovery (BFR) has exceeded a preamble transmission time threshold and transmitting a request in response to the preamble transmission time threshold having been exceeded.

Similarly, one such embodiment includes determining whether an accumulated time of a preamble transmission during the BFR within a monitoring window has exceeded an accumulated time threshold and transmitting a request in response to the accumulated time threshold having been exceeded.

Similarly, one such embodiment includes determining whether a quantity of the BFR has exceeded a BFR quantity threshold and transmitting a request in response to the BFR quantity threshold having been exceeded.

Similarly, one such embodiment includes determining whether a quantity of beam failure instance from lower layers has exceeded a beam failure instance quantity threshold and transmitting a request in response to the beam failure instance quantity threshold having been exceeded.

Similarly, one such embodiment includes determining whether a time of a radio problem recovery period has exceeded a radio problem recovery period threshold and transmitting a request in response to the radio problem recovery period threshold having been exceeded.

Similarly, one such embodiment includes determining whether an accumulated time of a radio problem recovery period within a monitoring window has exceeded an accumulated time threshold and transmitting a request in response to the accumulated time threshold having been exceeded.

Similarly, one such embodiment includes determining whether a quantity of a radio problem recovery within a monitoring window has exceeded a radio problem recovery threshold and transmitting a request in response to the radio problem recovery threshold having been exceeded.

Similarly, one such embodiment includes determining whether a quantity of out of synchronization indications within a monitoring window has exceeded an out of synchronization indication threshold; and transmitting a request in response to the out of synchronization indication threshold having been exceeded.

Similarly, one such embodiment includes determining whether a reference signal received power (RSRP) or a reference signal received quality (RSRQ) of a link has dropped below a minimum RSRP threshold or a minimum RSRQ threshold and transmitting a request in response to the RSRP or the RSRQ of the link having dropped below the minimum RSRP threshold or the minimum RSRQ threshold.

Similarly, one such embodiment includes determining whether a number of the RSRP or the RSRQ of a link within a monitoring window has dropped below a minimum RSRP number threshold or a minimum RSRQ number threshold and transmitting a request in response to the number of the RSRP or the number of the RSRQ of the link within a monitoring window having dropped below the minimum RSRP number threshold or the minimum RSRQ number threshold.

According to an exemplary embodiment, the IAB node within a network radio link topology may take on various roles including a child IAB node, a parent IAB node, an IAB node to execute a change of second serving IAB node, a serving IAB node, and etc. The network may also transmit signaling to alter the network link topology. According to an embodiment, transmitting the request to trigger the switch from the first network link topology to the second network link topology includes transmitting a request to the upstream IAB node which is a first upstream IAB node to add a second upstream IAB node, receiving a radio resource control (RRC) connection reconfiguration message which comprises information of the second upstream IAB node, and communicating with the second upstream IAB node so as to operate under the second network topology.

Transmitting the request to trigger the switch from the first network link topology to the second network link topology may include transmitting a request to the upstream IAB node which is a first upstream IAB node to release a second upstream IAB node, receiving a RRC connection reconfiguration message, and releasing the second upstream IAB node based on the RRC connection reconfiguration message so as to operate under the second network topology.

Transmitting the request to trigger the switch from the first network link topology to the second network link topology includes transmitting a request to the upstream IAB node which is a first upstream IAB node to release a second upstream IAB node and add a third upstream IAB node, receiving a RRC connection reconfiguration message which includes information of the third upstream IAB node, and releasing the second upstream IAB node based on the RRC connection reconfiguration message and communicating with the third upstream IAB node so as to operate under the second network topology.

When the upstream IAB node is a first upstream IAB node, transmitting the request to trigger the switch from the first network link topology to the second network link topology including transmitting a request for handover to an upstream IAB node, receiving a RRC connection reconfiguration message which includes information of a second upstream IAB node, and communicating with the second upstream IAB node so as to operate under the second network topology.

When the first network link topology is dual connectivity and the upstream IAB node is the first upstream IAB node, communicating with the second upstream IAB node so as to operate under the second network topology further including transmitting an RRC connection reconfiguration complete message to the second upstream IAB node.

When the first network link topology is dual connectivity and the upstream IAB node is the second upstream IAB node, communicating with the second upstream IAB node so as to operate under the second network topology further including transmitting an RRC connection reconfiguration complete message to the second upstream IAB node.

When the first network link topology is single connectivity and the upstream IAB node is the first upstream IAB node, communicating with the second upstream IAB node so as to operate under the second network topology further including performing a random-access procedure with the second upstream IAB node.

When the first network link topology is dual connectivity and the IAB node is the first serving IAB node, transmitting the request for handover to the IAB node further including determining an IAB node which is the second serving IAB node to change from the first network link topology to the second network link topology.

When the first network link topology is dual connectivity and the IAB node is the second serving IAB node, transmitting the request for handover to the IAB node further including determining an IAB node which is the first serving IAB node to change from the first network link topology to the second network link topology. When network link topology is single connectivity, transmitting a request for handover to an IAB node further including determining an IAB node to change from the first network link topology to the second network link topology.

FIG. 3B illustrates a network link topology adaptation method used by a receiving IAB node or a user equipment according to one of the exemplary embodiments of the disclosure. In step S311, the IAB node would transmit a topology adaptation configuration which includes a blockage-related parameter. In step S312, the IAB node would receive a request which indicates to trigger a switch from a first network link topology to a second network link topology. In step S313, the IAB node would transmit a command to trigger a switch from a first network link topology to a second network link topology.

Receiving a request which indicates to trigger the switch from the a first network link topology to the second network link topology and transmitting the command to trigger the switch from the first network link topology to the second network link topology may include receiving a request from a downstream IAB node, determining an IAB node to change from the first network link topology to the second network link topology, and transmitting a RRC connection reconfiguration message which includes information of the IAB node to the downstream node.

When the IAB node is a first serving IAB node, receiving the request which indicates to trigger the switch from the first network link topology to the second network link topology including receiving a request for handover from a downstream IAB node, transmitting a request for handover to an IAB node, receiving a request acknowledge message for handover from the IAB node, and transmitting an RRC connection reconfiguration message for handover to the downstream node.

Receiving the request which indicates to trigger the switch from the first network link topology to the second network link topology and transmitting the command to trigger the switch from the first network link topology to the second network link topology including receiving a request from a downstream IAB node, transmitting a request to an IAB node to change from the first network link topology to the second network link topology, and transmitting a RRC connection reconfiguration message which comprises information of the IAB node to the downstream node to release the IAB node.

Receiving the request which indicates to trigger the switch from the first network link topology to the second network link topology and transmitting the command to trigger the switch from the first network link topology to the second network link topology including receiving a request from a downstream IAB node, determining a first IAB node and transmitting a request to a second IAB node to change from the first network link topology to the second network link topology, and transmitting a RRC connection reconfiguration message which includes information of the first IAB node for addition and the second IAB node for release to the downstream node.

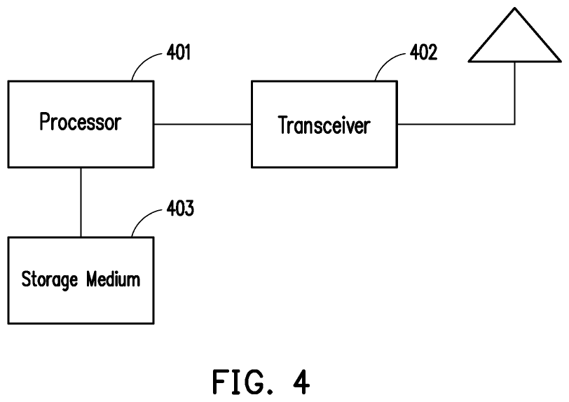

FIG. 4 illustrates the hardware block diagram of an IAB node according to one of the exemplary embodiments of the disclosure. The hardware of the IAB node would include not limited to a hardware processor 401, a hardware transceiver 402 which may include integrated or separate transmitter and receiver, and non-transitory storage medium 403. The hardware processor 401 is electrically connected to the hardware transceiver 402 and the non-transitory storage medium 403 and configured at least for implementing the network link topology adaptation method for an integrated access and backhaul (IAB) node and its exemplary embodiments.

The hardware transceiver 402 may include one or more transmitters and receivers configured to transmit and receive signals respectively in the radio frequency or in the mmWave frequency. The hardware transceiver 402 may also perform operations such as low noise amplifying, impedance matching, frequency mixing, up or down frequency conversion, filtering, amplifying, and so forth. The hardware transceiver 402 may each include one or more analog-to-digital (A/D) and digital-to-analog (D/A) converters which are configured to convert from an analog signal format to a digital signal format during uplink signal processing and from a digital signal format to an analog signal format during downlink signal processing. The hardware transceiver 402 may further include an antenna array which may include one or multiple antennas to transmit and receive omni-directional antenna beams or directional antenna beams. The hardware transceiver 402 could be connected to an inter-base station interface to communicate with other IAB nodes or base stations, a backhaul interface, to communicate with other IAB nodes or the core network, and etc.

The hardware processor 401 is configured to process digital signals and to perform procedures of the proposed hierarchical registration method in accordance with the proposed exemplary embodiments of the disclosure. Also, the hardware processor 401 may access to the non-transitory storage medium 403 which stores programming codes, codebook configurations, buffered data, and record configurations assigned by the hardware processor 401. The hardware processor 401 could be implemented by using programmable units such as a micro-processor, a micro-controller, a DSP chips, FPGA, etc. The functions of the hardware processor 401 may also be implemented with separate electronic devices or ICs. It should be noted that the functions of hardware processor 401 may be implemented with either hardware or software.

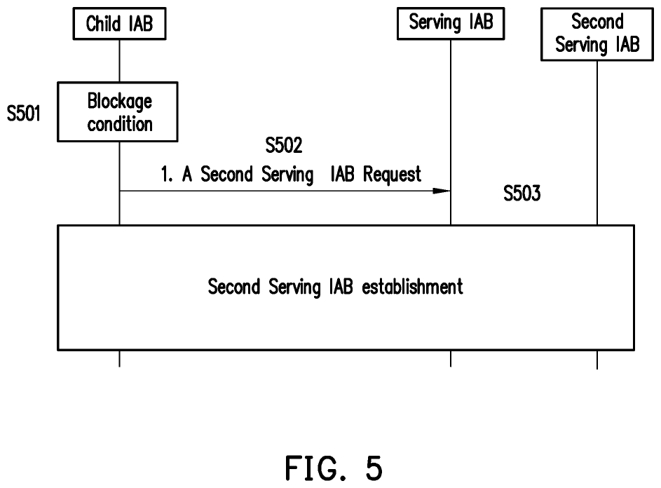

To further elucidate the inventive concepts as previous described, the disclosure provides various exemplary embodiments and examples as shown in FIG. 5-FIG. 23 and their corresponding written descriptions to describe the inventive concepts in more details. FIG. 5 is a signaling diagram which illustrates transmitting a Second Serving IAB Request to trigger a dual connectivity (DC) scenario during which another IAB node could be added, removed, or changed according to one of the exemplary embodiments of the disclosure. In step S501, a child IAB node would detect whether the blockage of a radio link has occurred. After the blockage of the radio link has been determined to have occurred, in step S502, the child IAB node would send out a second serving IAB request to a serving IAB node. In response to receiving the second serving IAB request, in step S503, the serving IAB node may locate a second serving IAB node so as to change the current network radio link topology by possibly re-route the radio link through the second serving IAB.

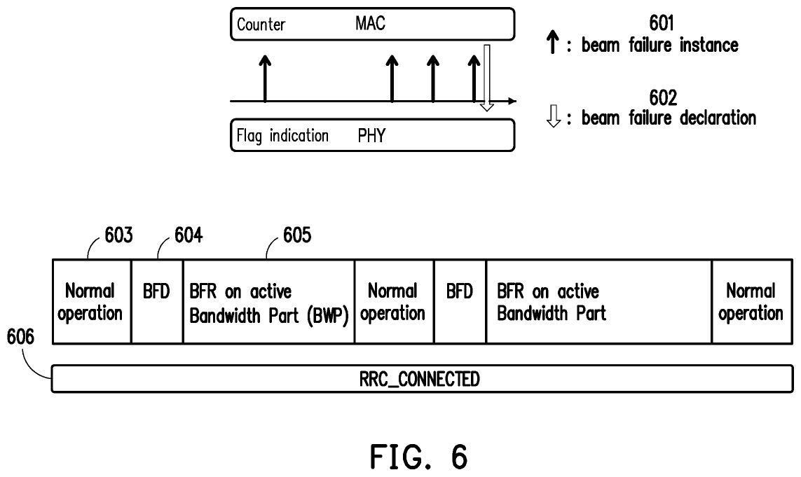

In order to detect a potential blockage condition, the detection could be performed based on a BFR mechanism. FIG. 6 illustrates a BFR detection mechanism according to one of the exemplary embodiments of the disclosure. Referring to FIG. 6, the PHY layer would utilize a flag to indicate whether a beam failure instance 601 has occurred. Once a beam failure instance 601 has occurred, such information is received by the MAC layer which would updates a counter to keep track the number of beam failure instances 601. When the number of beam failure instances 601 has exceeded a predetermined number during normal operation, the MAC layer would transmit a beam failure declaration (BFD) 602 to the PHY layer during the window of the BFD period 604. Next, upon receiving the BFD 602, the blockage condition is determined to have occurred. The, the beam failure recovery (BFR) 605 on active bandwidth part (BWP) would commence. Upon the successful completion of the BFR 605, the IAB node may keep staying in an RRC CONNECTED state 606 with.

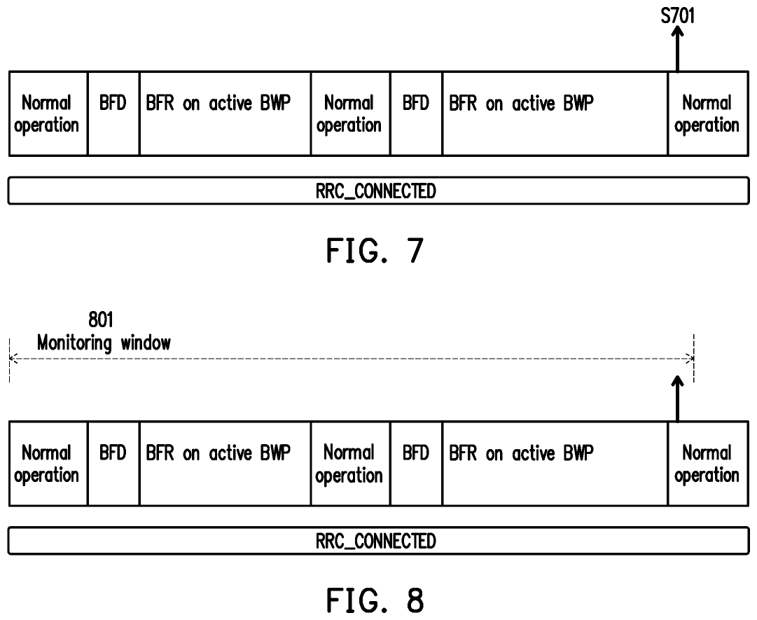

FIG. 7 illustrates a first exemplary embodiment of the BFR detection mechanism. In this exemplary embodiment, a child IAB node would determine whether the time of a preamble transmission during a BFR period has exceeded a preamble transmission time threshold. The child IAB node in step S701 may transmit a second serving IAB request (e.g. S502) in response to determining that the time of a preamble transmission during the BFR period has exceeded the preamble transmission time threshold. After transmitting the second serving IAB request, the child node could be simultaneously connected to both the first serving IAB node (i.e. the current serving IAB node) and the second serving IAB node and thus there could be two possible paths between the child IAB node and the IAB donor. One or both of the two possible paths could be used the transmit data upstream or to transmit data downstream.

FIG. 8 illustrates a second exemplary embodiment of the BFR detection mechanism. In this exemplary embodiment, the child IAB node would determine, within the monitoring window 801 having a duration T1, whether an accumulated time of a preamble transmission during a BFR period has exceeded an accumulated time threshold. The child IAB node would transmit the second serving IAB request (e.g. S502) in response to the accumulated time threshold having been exceeded during the monitoring window. Thus, the child IAB node could be dually connected with a first serving IAB node and a second serving IAB node.

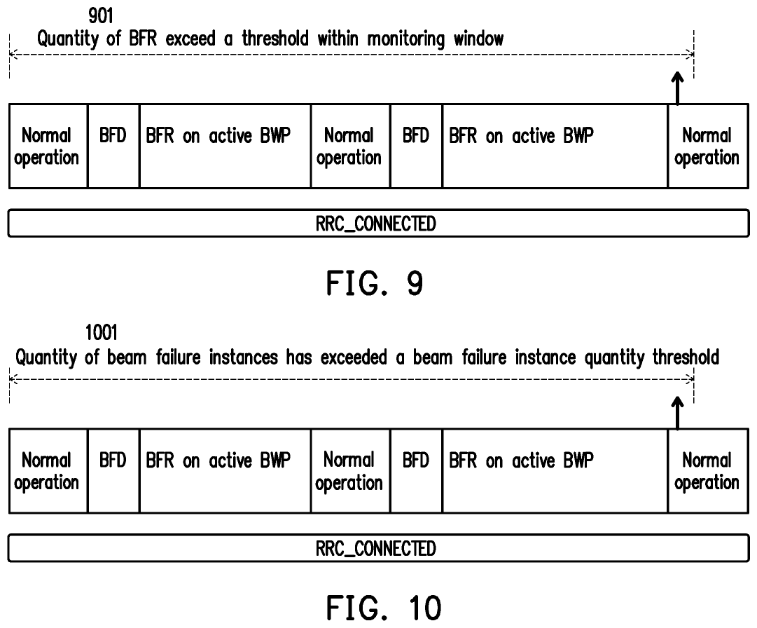

FIG. 9 illustrates a third exemplary embodiment of the BFR detection mechanism. In this exemplary embodiment, a child IAB node would determine, within the monitoring window 901, how many instances of BFRs have occurred so as to determine whether a quantity of the BFRs has exceeded a BFR quantity threshold. The child IAB node would transmit a second serving IAB request (e.g. S502) in response to the BFR quantity threshold having been exceeded during the monitoring window. Thus, the child IAB node could be dually connected with a first serving IAB node and a second serving IAB node.

FIG. 10 illustrates a fourth exemplary embodiment of the BFR detection mechanism. In this exemplary embodiment, a child IAB node would determine, within the monitoring window 1001, how many instances of beam failure indication has occurred so as to determine whether a quantity of beam failure instance has exceeded a beam failure instance quantity threshold. The child IAB node would transmit a second serving IAB request (e.g. S502) in response to the beam failure instance quantity threshold having been exceeded within the monitoring window. Thus, the child IAB node could be dually connected with a first serving IAB node and a second serving IAB node.

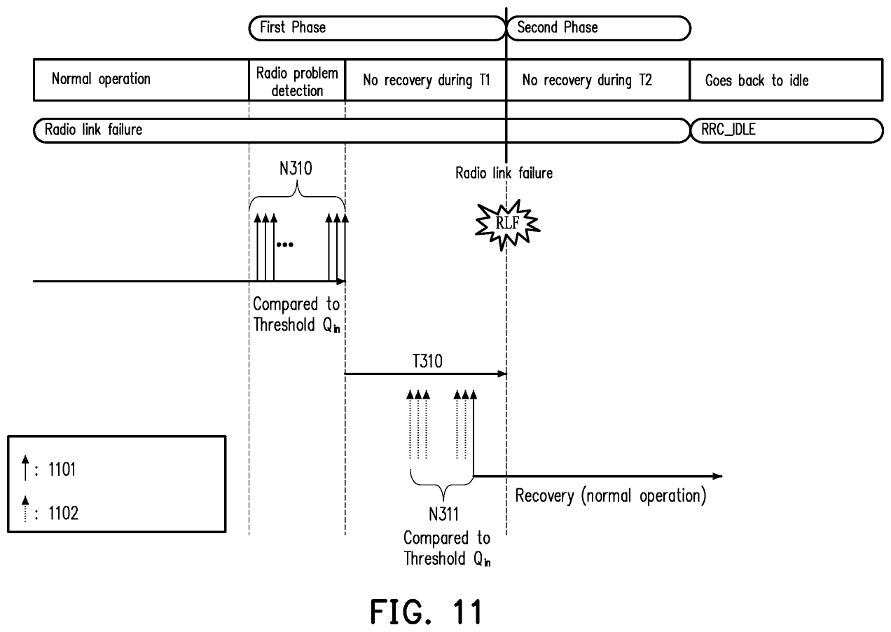

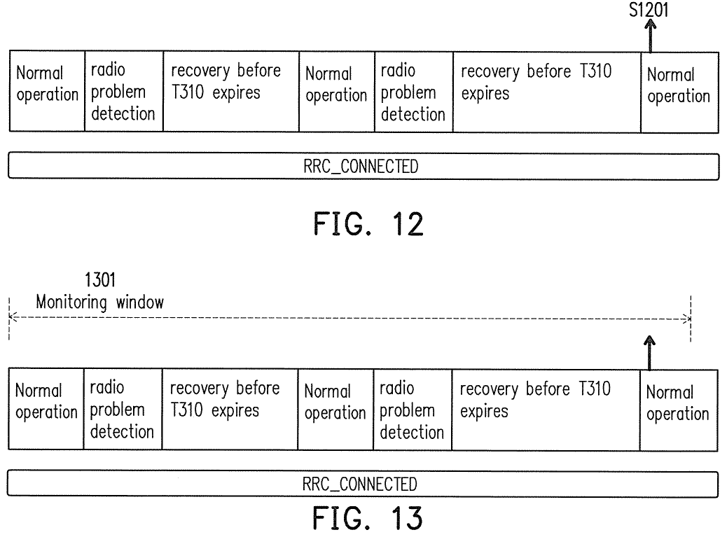

In order to detect a potential blockage condition, the detection could be performed based on an RLF detection mechanism. FIG. 11 illustrates an RLF detection mechanism according to one of the exemplary embodiments of the disclosure. After a period of normal operation, an IAB node may receive one or more instances of out-of-synchronization indications 1101 and in-of-synchronization indications 1102. Thus, the IAB node may perform a radio problem detection by computing a total number of out-of-synchronization indication. Assuming that the number of out-of-synchronization is greater than N310, then the IAB node would compute a total number of in-of-synchronization indication during the radio problem recovery period T310. Assuming that total number of in-of-synchronization indication is greater than N311, the radio problem recovery is successful and the IAB node enters a normal operation. Otherwise, an RLF is declared. FIG. 12 illustrates a first exemplary embodiment of the RLF detection mechanism. In this exemplary embodiment, a child IAB node may determine whether the duration of a radio problem recovery period has exceeded a radio problem recovery period threshold. The child IAB node would transmit a second serving IAB request (e.g. 502) in response to the duration of a radio problem recovery period having exceeded a radio problem recovery period threshold. Thus, in step S1201, the child IAB node could be dually connected with a first serving IAB node and a second serving IAB node.

FIG. 13 illustrates a second exemplary embodiment of the RLF detection mechanism. In this exemplary embodiment, a child IAB node may determine, within the monitoring window S1301, whether an accumulated time of a radio problem recovery period has exceeded an accumulated time threshold. The child IAB node would transmit a second serving IAB request (e.g. S502) in response to the accumulated time threshold having been exceeded. Thus, the child IAB node could be dually connected with a first serving IAB node and a second serving IAB node.

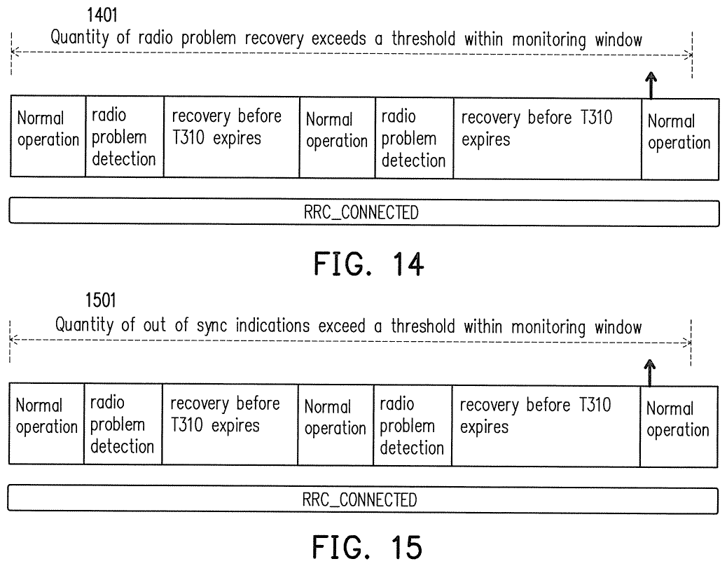

FIG. 14 illustrates a third exemplary embodiment of the RLF detection mechanism. In this exemplary embodiment, a child IAB node may, within the monitoring window S1401, determine whether a quantity (e.g. the number of times) of a radio problem recovery has exceeded a radio problem recovery threshold. The child IAB node would transmit a second serving IAB request (e.g. S502) in response to the radio problem recovery threshold having been exceeded. Thus, the child IAB node could be dually connected with a first serving IAB node and a second serving IAB node.

FIG. 15 illustrates a fourth exemplary embodiment of the RLF detection mechanism. In this exemplary embodiment, a child IAB node may, within the monitoring window S1501, determine whether a quantity of out of synchronization indications has exceeded an out of synchronization indication threshold. The child IAB node would transmit a second serving IAB request (e.g. S502) in response to the out of synchronization indication threshold having been exceeded. Thus, the child IAB node could be dually connected with a first serving IAB node and a second serving IAB node.

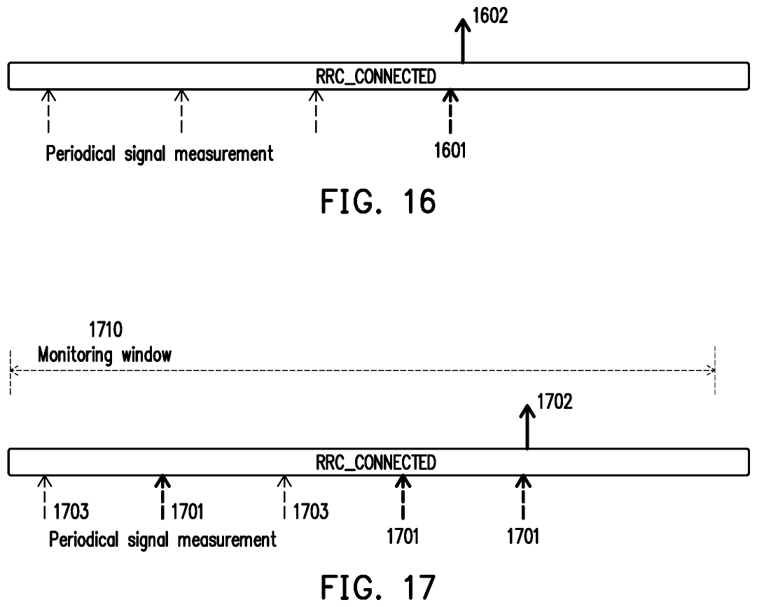

In order to detect a potential blockage condition, the detection could be performed based on measuring a reference signal and subsequently evaluate the RSRP or RSRQ of the reference signal. Such evaluation could be performed by using a monitoring window or without a monitoring window. FIG. 16 illustrates a first exemplary embodiment of an RSRP/RSRQ evaluation mechanism. In this exemplary embodiment, a child IAB node may determine whether the RSRP or the RSRQ of a reference signal received from a first or second serving IAB node has dropped below a minimum RSRP threshold or a minimum RSRQ threshold. As shown in FIG. 16, the child IAB node may perform periodic measurements of reference signals. Assuming that the child IAB node may have determined that a reference signal S1601 has dropped below the minimum RSRP threshold or the minimum RSRQ threshold.

Then in step S1602, the child IAB node would transmit a second serving IAB request (e.g. S502) to add, release, or change a second IAB serving node so as to be dually connected with the first serving IAB node and a second serving IAB node.

FIG. 17 illustrates a second exemplary embodiment of a RSRP/RSRQ evaluation mechanism. In this exemplary embodiment, a child IAB node may determine, within the monitoring window 1710, whether a number of the RSRP or the RSRQ of a link which has dropped below the minimum requirement exceeds a RSRP number threshold or a RSRQ number threshold. The child IAB node would transmit a second serving IAB request (e.g. 502) in response to the number of the RSRP or the number of the RSRQ of the link having dropped below the minimum requirement exceeds a RSRP number threshold or a RSRQ number threshold within the monitoring window 1710. As shown in FIG. 17, assuming that periodic measurements (e.g. 1701 1703) are performed but a few reference signal measurements 1701 have failed to meet the minimum RSRP or RSRQ requirement, and the number of reference signal measurements 1701 that failed to meet the minimum RSRP or RSRQ requirement has exceeded a RSRP number threshold or a RSRQ number threshold within the monitoring window 1710. Thus, the child IAB node may transmit a second serving IAB request (e.g. 502) to add, release, or change a second serving node. The child IAB node could then be dually connected to both a serving IAB serving node and the second IAB serving node.

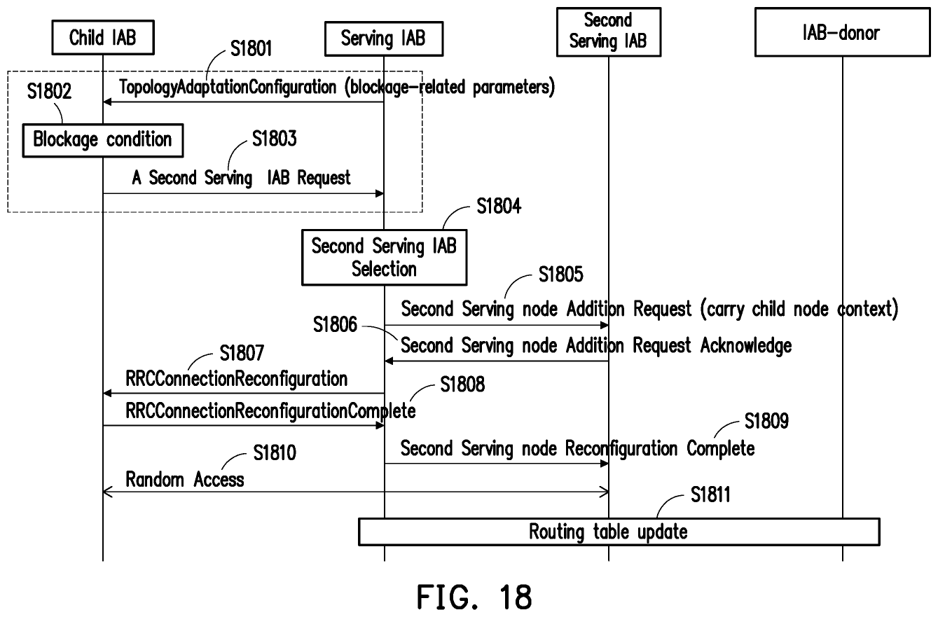

After an IAB node has determined that a blockage condition has occurred, the child IAB node may add a second IAB serving node. FIG. 18 is a signaling diagram which illustrates an addition of a second serving IAB node according to one of the exemplary embodiments of the disclosure. In step S1801, a first serving IAB node would transmit to the child IAB node a topology adaptation configuration message which may include blockage-related parameters. The topology adaptation configuration message is for configuring or reconfiguring a child IAB node to a particular network link topology. In step S1802, the child IAB node would continuously detect whether there is a blockage in its radio link with the first serving IAB node based on the blockage-related parameters. In step S1803, in response to the blockage condition having been detected, the first serving IAB node would receive from the child IAB node a second serving IAB request. In step S1804, the selection of a second serving IAB node could be made, and the first serving IAB node would receive information about the second serving IAB node.

In step S1805, the first serving IAB node would transmit, to a second serving IAB node, a second serving node addition request which would include the context of the child node. In step S1806, the first serving IAB node would receive, from the second serving IAB node, a second serving node addition request acknowledgement. In step S1807, the first serving IAB node would transmit, to the child IAB node, an RRC connection reconfiguration message. In step S1808, the child IAB node would transmit, to the first serving IAB node, an RRC connection reconfiguration complete message. In step S1809, the first serving IAB node would forward the second serving node reconfiguration complete message to the second serving IAB node. In step S1810, the child IAB node would perform a random-access procedure in order for the connection between the child IAB node and the second serving IAB node to commence. In step S1811, the first serving IAB node, the second serving IAB node, and the IAB donor would each update one's own routing table.

In step S1804, the second serving IAB node could be selected based one or more of the following criteria which include the SSB signal strength of an IAB node, the loading of an IAB node, the minimum number of hops of an IAB node from an IAB donor, the loading of IAB nodes along a data path and etc. In order to implement step S1804, there could be at least two alternatives.

In the first alternative, each one of all IAB nodes may exchange the information of its respective loading information and its respective hop position periodically with its IAB donor. When the child IAB node sends a second serving IAB Request which includes the signal strength information of its neighbor IAB nodes, its serving node (or donor) may select a second serving IAB node accordingly. The advantage of the first alternative is that the selection of the second serving IAB node may be optimized.

In the second alternative, a child IAB node may collect information including signal strengths, loading information, hop position, and etc. from neighbor IAB nodes via a broadcasting system information message. The child IAB node may then report such information to its serving IAB node when sending out a second serving IAB request message to its serving node. The advantage of the second alternative is that the child IAB node would only send a candidate list that has qualified neighboring IAB nodes and measurement information to its serving node so that signaling overhead could be reduced.

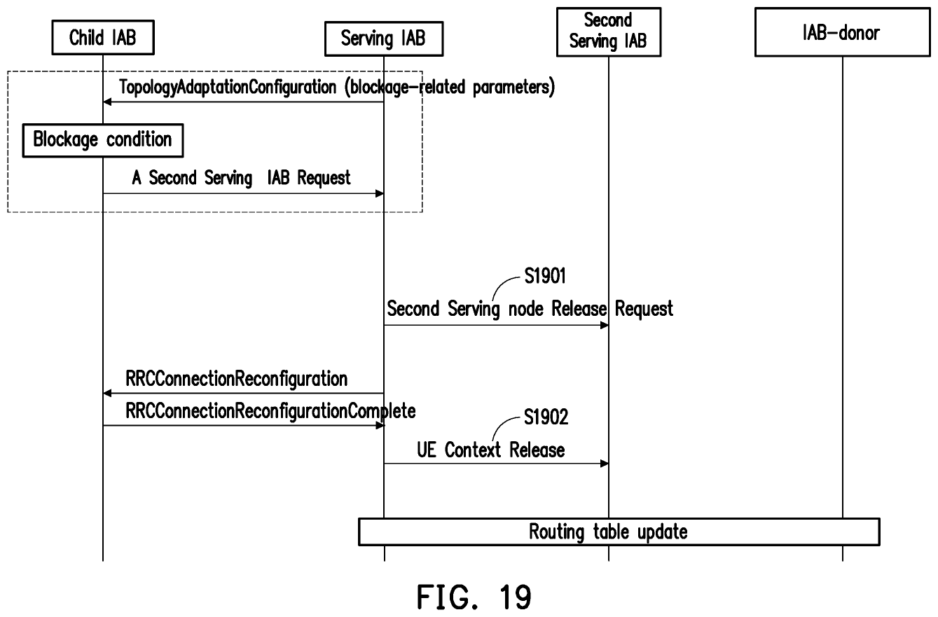

A child IAB node may release a previously added second serving IAB node under some circumstances. For example, the first serving IAB node could be good enough again and thus a dual connectivity with a second serving IAB node could then be considered as redundant. For example, the radio link with the second serving IAB node could become unreliable and thus a dual connectivity with a second serving IAB node could then also be considered as redundant. FIG. 19 is a signaling diagram which illustrates releasing a second serving IAB according to one of the exemplary embodiments of the disclosure. The signaling to release the second serving IAB node is mostly the same except as FIG. 18 except for S1901 and S1902.

In detail, a first serving IAB node would transmit to the child IAB node a topology adaptation configuration message which may include blockage-related parameters. The child IAB node would then continuously detect whether there is a blockage in its radio link with the first serving IAB node based on the blockage-related parameters. The first serving IAB node may at some point receive from the child IAB node a second serving IAB request. In response to the connection with the second serving IAB node being no longer needed, in step 51901, the first serving IAB node would transmit a second serving node release request. The first serving IAB node would transmit, to the child IAB node, an RRC connection reconfiguration message. The child IAB node would transmit, to the first serving IAB node, an RRC connection reconfiguration complete message. In step S1902, the first serving IAB node would transmit to the second serving node a UE context release message. In response to receiving the UE context release message, the second serving IAB node would stop connecting to the child IAB node. Next, the first serving IAB node, the second serving IAB node, and the IAB donor would each update one's own routing table.

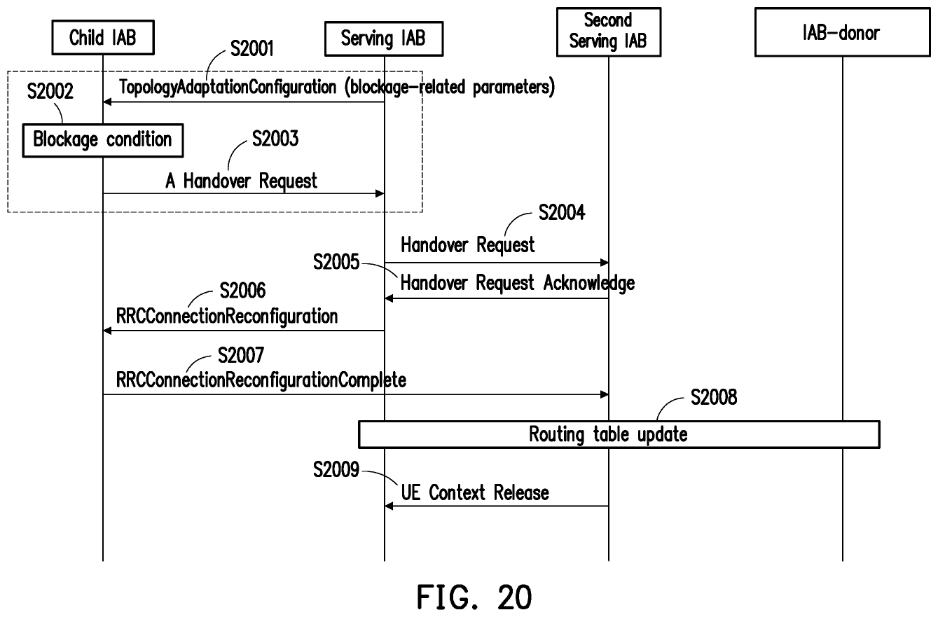

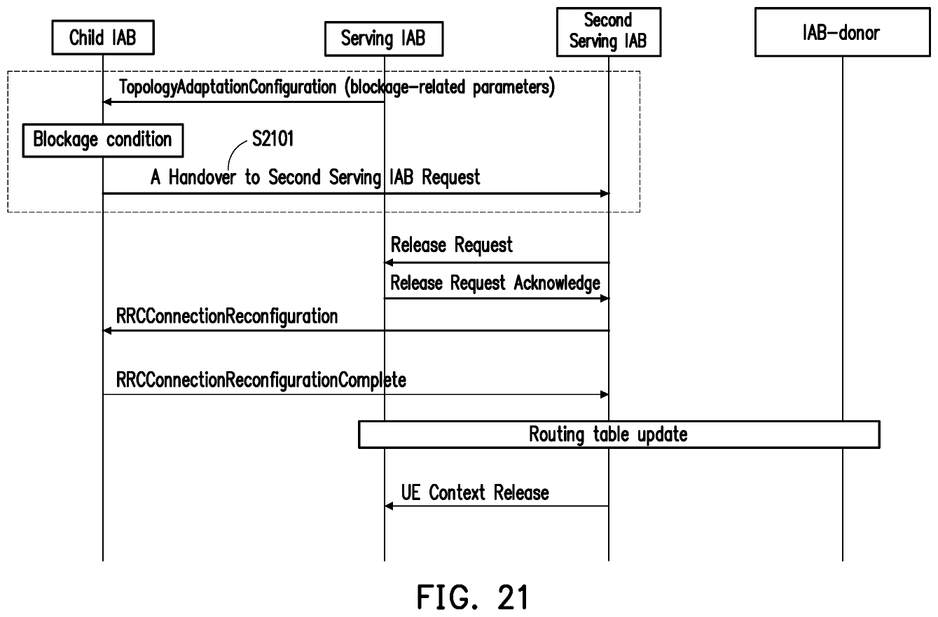

After a child IAB node has determined that a blockage condition has occurred, the child IAB node may also choose to hand over the radio link to another IAB node. For implementing the handover procedure, the disclosure would provide three options as shown in FIGS. 20-22, and for the options in FIG. 20 and FIG. 21 support the feature that a Secondary Cell Group (SCG) can be changed to a Master Cell group (MCG) directly instead of executing the add/release procedure in LTE dual connectivity. Due to the feature that IAB nodes are mostly physically fixed, the second serving node could be a good candidate to become a node of handover target, and thus the handover time could be minimized as no random-access procedure is required.

FIG. 20 is a signaling diagram which illustrates a first exemplary embodiment of handing over the first serving IAB node to a second serving IAB node. In step S2001, a first serving IAB node would transmit to the child IAB node a topology adaptation configuration message which may include blockage-related parameters. The topology adaptation configuration message is for configuring or reconfiguring a child IAB node to a particular network link topology. In step S2002, the child IAB node would continuously detect whether there is a blockage in its radio link with the first serving IAB node based on the blockage-related parameters. In step S2003, in response to the blockage condition having been detected, the first serving IAB node would receive from the child IAB node a handover request. In step S2004, the first serving IAB node transmit, to a second serving IAB node, a handover request. In step S2005, the first serving IAB node would receive, from the second serving IAB node, a handover request acknowledgement. In step S2006, the first serving IAB node would transmit, to the child IAB node, an RRC connection reconfiguration message. In step S2007, the child IAB node would transmit, to the second serving IAB node, an RRC connection reconfiguration complete message. In step S2008, the first serving IAB node, the second serving IAB node, and the IAB donor would each update one's own routing table. In step S2009, the second serving IAB node would transmit a UE context release message to the first serving IAB node.

FIG. 21 is a signaling diagram which illustrates a second exemplary embodiment of handing over the first serving IAB node to a second serving IAB node. This exemplary embodiment is similar to FIG. 20 except for S2101 and the procedures related to release requests. First, a first serving IAB node would transmit to the child IAB node a topology adaptation configuration message which may include blockage-related parameters. The topology adaptation configuration message is for configuring or reconfiguring a child IAB node to a particular network link topology. Next, the child IAB node would continuously detect whether there is a blockage in its radio link with the first serving IAB node based on the blockage-related parameters. In in response to the blockage condition having been detected, in step S2101, the child IAB node would transmit, to the second serving IAB node, a handover to a second serving IAB request. In response to receiving the handover to second serving IAB request, the second serving IAB node would transmit a release request to the first serving IAB. The first serving IAB node would in turn transmit a release request acknowledgement to the second serving IAB node. Next, the second serving IAB node would transmit, to the child IAB node, an RRC connection reconfiguration message. In response, the child IAB node would transmit, to the second serving IAB node, an RRC connection reconfiguration complete message. Next, the first serving IAB node, the second serving IAB node, and the IAB donor would each update one's own routing table. The second serving IAB node would complete the handover procedures by transmitting a UE context release message to the first serving IAB node.

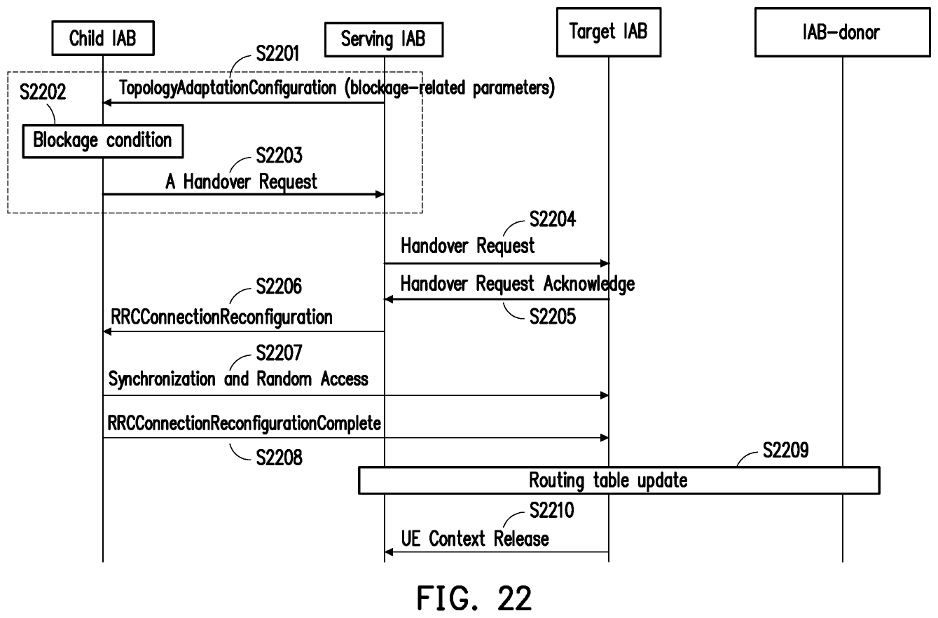

FIG. 22 illustrates a signaling diagram which illustrates a third exemplary embodiment of handing over the first serving IAB node to a target serving IAB node. In step S2201, a first serving IAB node would transmit to the child IAB node a topology adaptation configuration message which may include blockage-related parameters. The topology adaptation configuration message is for configuring or reconfiguring a child IAB node to a particular network link topology. In step S2202, the child IAB node would continuously detect whether there is a blockage in its radio link with the first serving IAB node based on the blockage-related parameters. In step S2203, in response to the blockage condition having been detected, the first serving IAB node would receive from the child IAB node a handover request. In step S2204, the first serving IAB node would transmit, to a target IAB node, a handover request. In step S2205, in response to receiving the handover request, the target IAB node would transmit, to the first serving IAB node, a handover request acknowledgement. In step S2206, the first serving IAB node would transmit, to the child IAB node, an RRC connection reconfiguration message. In step S2207, the child IAB node would perform device synchronization procedures and random-access procedures with the target IAB node. In step S2208, the child IAB node would transmit, to the target IAB node, an RRC connection reconfiguration complete message. In step S2209 the first serving IAB node, the target IAB node, and the IAB donor would each update one's own routing table. In step S2210 the target IAB node would transmit a UE context release message to the first serving IAB node.

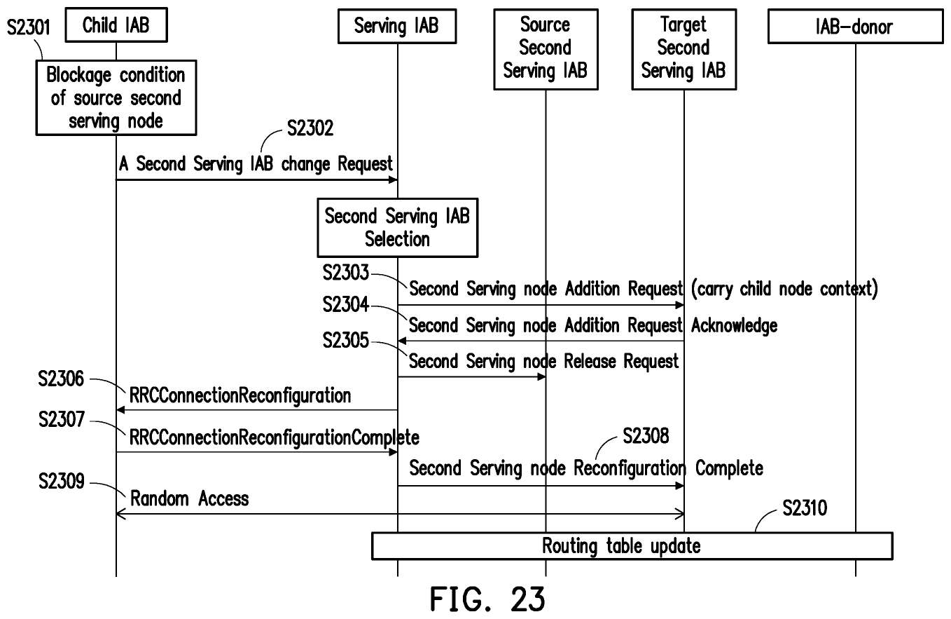

After a child IAB node has determined that a blockage condition or a deterioration has occurred on the radio link with the second source serving IAB node, the child IAB node may initiate a change of the source second serving IAB node to a target second serving IAB node. FIG. 23 illustrates a signaling diagram which illustrates changing a second serving IAB node according to one of the exemplary embodiments of the disclosure. In step S2301, the child IAB node is assumed to have detected a blockage condition in its radio link with the source second serving IAB node. In step S2302, in response to the blockage condition having been detected, the first serving IAB node would receive from the child IAB node a second serving IAB change request. In step S2303, after the selection of a target second serving IAB node having been made, and the first serving IAB node would transmit, to a target second serving IAB node, a second serving node addition request which would include a context of the child IAB node. In step S2304, the first serving IAB node would receive, from the target second serving IAB node, a second serving node addition request acknowledgement. In step S2305, the first serving IAB node would transmit, to the source second serving IAB node, a second serving node release request message.

In step S2306, the first serving IAB node would transmit, to the child IAB node, an RRC connection reconfiguration message. In step S2307, the child IAB node would transmit, to the first serving IAB node, an RRC connection reconfiguration complete message. In step S2308, the first serving IAB node would forward the second serving node reconfiguration complete message to the target second serving IAB node. In step S2309, the child IAB node would perform a random-access procedure with the target second serving IAB node. In step S2310, the first serving IAB node, the second serving IAB node, and the IAB donor would each update one's own routing table.

In view of the aforementioned descriptions, the disclosure is suitable for being used in a 5G NR wireless communication system and beyond and is able to detect a blockage condition or a changing network condition of a radio link and adjust the overall network link topology to dynamically scope with the blockage condition or the changing condition of the network.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

1. A network link topology adaptation method used by an integrated access and backhaul (IAB) node or User Equipment (UE), the method comprising:
receiving a topology adaptation configuration which comprises a blockage-related parameter from an upstream IAB node;
determining whether a blockage condition of a radio link has occurred based on the blockage-related parameter; and
transmitting a request to trigger a switch from a first network link topology to a second network link topology.

2. The method of claim 1, wherein the determining whether the blockage condition has occurred based on the blockage-related parameter comprising:
determining whether one or more preamble transmission during a Beam Failure Recovery (BFR) has exceeded a preamble transmission time threshold; and
transmitting a request in response to the preamble transmission time threshold having been exceeded.

3. The method of claim 1, wherein the determining whether the blockage condition has occurred based on the blockage-related parameter comprising:
determining whether an accumulated time of a preamble transmission during the BFR within a monitoring window has exceeded an accumulated time threshold; and
transmitting a request in response to the accumulated time threshold having been exceeded.

4. The method of claim 1, wherein the determining whether the blockage condition has occurred based on the blockage-related parameter comprising:
determining whether a quantity of the BFR has exceeded a BFR quantity threshold; and
transmitting a request in response to the BFR quantity threshold having been exceeded.

5. The method of claim 1, wherein the determining whether the blockage condition has occurred based on the blockage-related parameter comprising:
determining whether a quantity of beam failure instance from lower layers has exceeded a beam failure instance quantity threshold; and
transmitting a request in response to the beam failure instance quantity threshold having been exceeded.

6. The method of claim 1, wherein the determining whether the blockage condition has occurred based on the blockage-related parameter comprising:
determining whether a time of a radio problem recovery period has exceeded a radio problem recovery period threshold; and
transmitting a request in response to the radio problem recovery period threshold having been exceeded.

7. The method of claim 1, wherein the determining whether the blockage condition has occurred based on the blockage-related parameter comprising:
determining whether an accumulated time of a radio problem recovery period within a monitoring window has exceeded an accumulated time threshold; and
transmitting a request in response to the accumulated time threshold having been exceeded.

8. The method of claim 1, wherein the determining whether the blockage condition has occurred based on the blockage-related parameter comprising:
determining whether a quantity of a radio problem recovery within a monitoring window has exceeded a radio problem recovery threshold; and
transmitting a request in response to the radio problem recovery threshold having been exceeded.

9. The method of claim 1, wherein the determining whether the blockage condition has occurred based on the blockage-related parameter comprising:
determining whether a quantity of out of synchronization indications within a monitoring window has exceeded an out of synchronization indication threshold; and
transmitting a request in response to the out of synchronization indication threshold having been exceeded.

10. The method of claim 1, wherein the determining whether the blockage condition has occurred based on the blockage-related parameter comprising:
determining whether a reference signal received power (RSRP) or a reference signal received quality (RSRQ) of a link has dropped below a minimum RSRP threshold or a minimum RSRQ threshold; and
transmitting a request in response to the RSRP or the RSRQ of the link having dropped below the minimum RSRP threshold or the minimum RSRQ threshold.

11. The method of claim 1, wherein the determining whether the blockage condition has occurred based on the blockage-related parameter comprising:
determining whether a number of a reference signal received power (RSRP) or a reference signal received quality (RSRQ), which is below a standard threshold, of a link within a monitoring window has exceeded a maximum RSRP number threshold or a maximum RSRQ number threshold; and
transmitting a request in response to the number of the RSRP or the number of the RSRQ, which is below the standard threshold, of the link within the monitoring window having exceeded the maximum RSRP number threshold or the maximum RSRQ number threshold.

12. The method of claim 1, wherein the transmitting a request to trigger a switch from a first network link topology to a second network link topology comprising:
transmitting a request to the upstream IAB node which is a first upstream IAB node to add a second upstream IAB node;
receiving a radio resource control (RRC) connection reconfiguration message which comprises information of the second upstream IAB node; and
communicating with the second upstream IAB node so as to operate under the second network link topology.

13. The method of claim 1, wherein the transmitting a request to trigger a switch from a first network link topology to a second network link topology comprising:
transmitting a request to the upstream IAB node which is a first upstream IAB node to release a second upstream IAB node;
receiving a RRC connection reconfiguration message; and
releasing the second upstream IAB node based on the RRC connection reconfiguration message so as to operate under the second link network topology.

14. The method of claim 1, wherein the transmitting a request to trigger a switch from a first network link topology to a second network link topology comprising:
transmitting a request to the upstream IAB node which is a first upstream IAB node to release a second upstream IAB node and add a third upstream IAB node;
receiving a RRC connection reconfiguration message which comprises information of the third upstream IAB node; and
releasing the second upstream IAB node based on the RRC connection reconfiguration message and communicating with the third upstream IAB node so as to operate under the second network link topology.

15. The method of claim 1, wherein the upstream IAB node is a first upstream IAB node and the transmitting a request to trigger a switch from a first network link topology to a second network link topology comprising:
transmitting a request for handover to the upstream IAB node;
receiving a RRC connection reconfiguration message which comprises information of a second upstream IAB node; and
communicating with the second upstream IAB node so as to operate under the second network link topology.

16. The method of claim 15, wherein the first network link topology is dual connectivity, the upstream IAB node is the first upstream IAB node, and the communicating with the second upstream IAB node so as to operate under the second network link topology further comprising:
transmitting a RRC connection reconfiguration complete message to the second upstream IAB node.

17. The method of claim 15, wherein the first network link topology is dual connectivity, the upstream IAB node is the second upstream IAB node, and the communicating with the second upstream IAB node so as to operate under the second network link topology further comprising:
transmitting a RRC connection reconfiguration complete message to the second upstream IAB node.

18. The method of claim 15, wherein the first network link topology is single connectivity, the upstream IAB node is the first upstream IAB node, and the communicating with the second upstream IAB node so as to operate under the second network link topology further comprising:
performing a random-access procedure with the second upstream IAB node.

19. An integrated access and backhaul (IAB) node or a user equipment (UE) comprising:
a transceiver; and
a processor coupled to the transceiver and is configured at least to:
receive, through the transceiver, a topology adaptation configuration which comprises a blockage-related parameter from an upstream IAB node;
determine whether a blockage condition of a radio link has occurred based on the blockage-related parameter; and
transmit, through the transceiver, a request to trigger a switch from a first network link topology to a second network link topology.

20. The IAB node of claim 19, wherein the processor is configured to determine whether the blockage condition has occurred based on the blockage-related parameter comprising:
determine whether one or more preamble transmission during a Beam Failure Recovery (BFR) has exceeded a preamble transmission time threshold; and
transmit, through the transceiver, a request in response to the preamble transmission time threshold having been exceeded.

21. The IAB node of claim 19, wherein the processor is configured to determine whether the blockage condition has occurred based on the blockage-related parameter comprising:
determine whether an accumulated time of a preamble transmission during the BFR within a monitoring window has exceeded an accumulated time threshold; and
transmit, through the transceiver, a request in response to the accumulated time threshold having been exceeded.

22. The IAB node of claim 19, wherein the processor is configured to determine whether the blockage condition has occurred based on the blockage-related parameter comprising:
determine whether a quantity of the BFR has exceeded a BFR quantity threshold; and
transmit, through the transceiver, a request in response to the BFR quantity threshold having been exceeded.

23. The IAB node of claim 19, wherein the processor is configured to determine whether the blockage condition has occurred based on the blockage-related parameter comprising:
determine whether a quantity of beam failure instance from lower layers has exceeded a beam failure instance quantity threshold; and
transmit, through the transceiver, a request in response to the beam failure instance quantity threshold having been exceeded.

24. The IAB node of claim 19, wherein the processor is configured to determine whether the blockage condition has occurred based on the blockage-related parameter comprising:
determine whether a time of a radio problem recovery period has exceeded a radio problem recovery period threshold; and
transmit, through the transceiver, a request in response to the radio problem recovery period threshold having been exceeded.

25. The IAB node of claim 19, wherein the processor is configured to determine whether the blockage condition has occurred based on the blockage-related parameter comprising:
determine whether an accumulated time of a radio problem recovery period within a monitoring window has exceeded an accumulated time threshold; and
transmit, ough the transceiver, a request in response to the accumulated time threshold having been exceeded.

26. The IAB node of claim 19, wherein the processor is configured to determine whether the blockage condition has occurred based on the blockage-related parameter comprising:
determine whether a quantity of a radio problem recovery has exceeded a radio problem recovery threshold; and
transmit, through the transceiver, a request in response to the radio problem recovery threshold having been exceeded.

27. The IAB node of claim 19, wherein the processor is configured to determine whether the blockage condition has occurred based on the blockage-related parameter comprising:
determine, whether a quantity of out of synchronization indications within a monitoring window has exceeded an out of synchronization indication threshold; and
transmit, through the transceiver, a request in response to the out of synchronization indication threshold having been exceeded.

28. The IAB node of claim 19, wherein the processor is configured to determine whether the blockage condition has occurred based on the blockage-related parameter comprising:
determine whether a reference signal received power (RSRP) or a reference signal received quality (RSRQ) of a link has dropped below a minimum RSRP threshold or a minimum RSRQ threshold; and
transmit, through the transceiver, a request in response to the RSRP or the RSRQ of the link having dropped below the minimum RSRP threshold or the minimum RSRQ threshold.

29. The IAB node of claim 19, wherein the processor is configured to determine whether the blockage condition has occurred based on the blockage-related parameter comprising:
determine whether a number of a reference signal received power (RSRP) or a reference signal received quality (RSRQ), which is below a standard threshold, of a link within a monitoring window has exceeded a maximum RSRP number threshold or a maximum RSRQ number threshold; and
transmit, through the transceiver, a request in response to the number of the RSRP or the number of the RSRQ of the link within the monitoring window having exceeded the maximum RSRP number threshold or the maximum RSRQ number threshold.

30. The IAB node of claim 19, wherein the processor is configured to transmit a request to trigger the switch from the first network link topology to the second network link topology comprising:
transmit, through the transceiver, a request to the upstream IAB node which is a first upstream IAB node to add a second upstream IAB node;
receive, through the transceiver, a radio resource control (RRC) connection reconfiguration message which comprises information of the second upstream IAB node; and
communicate, through the transceiver, with the second upstream IAB node so as to operate under the second network link topology.

31. The IAB node of claim 19, wherein the processor is configured to transmit a request to trigger the switch from the first network link topology to the second network link topology comprising:
transmit, through the transceiver, a request to the upstream IAB node which is a first upstream IAB node to release a second upstream IAB node;
receive, through the transceiver, a RRC connection reconfiguration message; and
release, through the transceiver, the second upstream IAB node based on the RRC connection reconfiguration message so as to operate under the second network link topology.

32. The IAB node of claim 19, wherein the processor is configured to transmit a request to trigger the switch from the first network link topology to the second network link topology comprising:
transmit, through the transceiver, a request to the upstream IAB node which is a first upstream IAB node to release a second upstream IAB node and add a third upstream IAB node;
receive, through the transceiver, a RRC connection reconfiguration message which comprises information of the third upstream IAB node; and
release the second upstream IAB node based on the RRC connection reconfiguration message and communicate with the third upstream IAB node so as to operate under the second network link topology.

33. The IAB node of claim 19, wherein the processor is configured to transmit a request to trigger the switch from the first network link topology to the second network link topology comprising:
transmit, through the transceiver, a request for handover to the upstream IAB node;
receive, through the transceiver, a RRC connection reconfiguration message which comprises information of a second upstream IAB node; and
communicate with the second upstream IAB node so as to operate under the second network link topology.

34. The IAB node of claim 33, wherein the first network link topology is dual connectivity, the upstream IAB node is a first upstream IAB node, and the processor is configured to communicate with the second upstream IAB node so as to operate under the second network link topology further comprising:
transmit, via the transceiver, a RRC connection reconfiguration complete message to the second upstream IAB node.

35. The IAB node of claim 33, wherein the first network link topology is dual connectivity, the upstream IAB node is the second upstream IAB node, and the processor is configured to communicate with the second upstream IAB node so as to operate under the second network link topology further comprising:
transmit, via the transceiver, a RRC connection reconfiguration complete message to the second upstream IAB node.

36. The IAB node of claim 33, wherein the first network link topology is single connectivity, the upstream IAB node is a first upstream IAB node, and the processor is configured to communicate with the second upstream IAB node so as to operate under the second network link topology further comprising:
perform a random-access procedure with the second upstream IAB node.

37. A network link topology adaptation method used by an integrated access and backhaul (IAB) node, the method comprising:
transmitting a topology adaptation configuration which comprises a blockage-related parameter;
receiving a request which indicates to trigger a switch from a first network link topology to a second network link topology; and
transmitting a command to trigger the switch from the first network link topology to the second network link topology.

38. The method of claim 37, wherein the receiving a request which indicates to trigger a switch from a first network link topology to a second network link topology and the transmitting a command to trigger a switch from the first network link topology to the second network link topology comprising:
receiving a request from a downstream IAB node;
determining the IAB node to change from the first network link topology to the second network link topology; and
transmitting a radio resource control (RRC) connection reconfiguration message which comprises information of the IAB node to a downstream node.

39. The method of claim 37, wherein the receiving a request which indicates to trigger a switch from a first network link topology to a second network link topology and the transmitting a command to trigger the switch from the first network link topology to the second network link topology comprising:
receiving a request from a downstream IAB node;
transmitting a request to another IAB node to change from the first network link topology to the second network link topology; and
transmitting a radio resource control (RRC) connection reconfiguration message which comprises information of the another IAB node to a downstream node to release the another IAB node.

40. The method of claim 37, wherein the receiving a request which indicates to trigger a switch from a first network link topology to a second network link topology and the transmitting a command to trigger the switch from the first network link topology to the second network link topology comprising:
receiving a request from a downstream IAB node;
determining a first IAB node and transmitting a request to a second IAB node to change from the first network link topology to the second network link topology; and
transmitting a radio resource control (RRC) connection reconfiguration message which comprises information of the first IAB node for addition and the second IAB node for release to a downstream node.

41. The method of claim 37, wherein the IAB node is a first serving IAB node and the receiving a request which indicates to trigger a switch from a first network link topology to a second network link topology comprising:
receiving a request for handover from a downstream IAB node;
transmitting a request for handover to another IAB node;
receiving a request acknowledge message for handover from the IAB node; and
transmitting an RRC connection reconfiguration message for handover to a downstream node.

42. The method of claim 41, wherein the first network link topology is dual connectivity, the IAB node is the first serving IAB node, and the transmitting a request for handover to the another IAB node further comprising:
determining the another IAB node which is a second serving IAB node to change from the first network link topology to the second network link topology.

43. The method of claim 41, wherein the first network link topology is dual connectivity, the another IAB node is a second serving IAB node, and the transmitting a request for handover to the another IAB node further comprising:
determining an IAB node which is the first serving IAB node to change from the first network link topology to the second network link topology.

44. The method of claim 41, wherein the first network link topology is single connectivity, and the transmitting a request for handover to the another IAB node further comprising: determining the another IAB node to change from the first network link topology to the second network link topology.

45. An integrated access and backhaul (IAB) node comprising:
a transceiver; and
a processor connected to the transceiver and configured at least to:
transmit a topology adaptation configuration which comprises a blockage-related parameter;
receive a request which indicates to trigger a switch ro first network link topology to a second network link topology; and
transmit a command to trigger the switch from the first network link topology to the second network link topology.

46. The IAB node of claim 45, wherein the first network link topology is dual connectivity, the IAB node is a first serving IAB node, and the processor is configured to transmit a request for handover to another IAB node further comprising:
determine the another IAB node which is a second serving IAB node to change from the first network link topology to the second network link topology.

47. The IAB node of claim 45, wherein the first network link topology is dual connectivity, the IAB node is a second serving IAB node, and the processor is configured to transmit a request for handover to another IAB node further comprising:
determine the another IAB node which is a first serving IAB node to change from the first network link topology to the second network link topology.

48. The IAB node of claim 45, wherein the first network link topology is single connectivity, and the processor is configured to transmit a request for handover to another IAB node further comprising:
determine the another IAB node to change from the first network link topology to the second network link topology.
